(19) United States
(12) Patent Application Publication
(10) Pub. No.: US 2024/0297774 A1
(43) Pub. Date: Sep. 5, 2024

(54) JOINT SENSING METHOD AND RELATED USER EQUIPMENT FOR ORTHOGONAL FREQUENCY DOMAIN MULTIPLEXING COMMUNICATION SYSTEM

(71) Applicant: MEDIATEK INC., Hsin-Chu (TW)

(72) Inventors: Rui Zhang, San Jose, CA (US); Tzu-Han Chou, San Jose, CA (US); Shiauhe Tsai, San Jose, CA (US)

(73) Assignee: MEDIATEK INC., Hsin-Chu (TW)

(21) Appl. No.: 18/581,407

(22) Filed: Feb. 20, 2024

Related U.S. Application Data
(60) Provisional application No. 63/486,483, filed on Feb. 23, 2023.

(51) Int. Cl. H04L 5/00; H04B 7/08

(52) U.S. Cl. CPC H04L 5/0098; H04B 7/0848; H04L 5/0007

(57) ABSTRACT

A joint sensing method for an orthogonal frequency domain multiplexing (OFDM) communication system includes configuring a plurality of reference signal (RS) patterns according to a delay and Doppler shift detection of a measured signal; and determining a two-dimensional (2D) self-ambiguity function according to a delay and sum approach; wherein the delay and sum approach is determined based on linear convolution and frequency binning in a time domain of the plurality of RS patterns; wherein the plurality of RS patterns are for a comb structure.

### CROSS REFERENCE TO RELATED APPLICATIONS

This application claims the benefit of U.S. Provisional Application No. 63/486,483, filed on Feb. 23, 2023. The content of the application is incorporated herein by reference.

### BACKGROUND

Conventional techniques of sensing object's distance and velocity via measured signal delay and Doppler shift detection are commonly utilized in radar engineering. The object's distance equals the signal delay multiplied by the speed of electromagnetic wave, and the object's velocity relative to the radar, divided by the carrier frequency, translates to the Doppler shift. In addition, communication signals possess similar radio characteristics and could be reused for sensing.

However, conventional 5G NR positioning reference signal (PRS) only considers delay detection, i.e. distance, for triangulation. Requirements for Doppler shift, i.e. object's velocity, are neglected.

Therefore, improvements are necessary to the conventional technique.

### SUMMARY

In light of this, the present invention provides a joint sensing method and related user equipment (UE) for an orthogonal frequency domain multiplexing (OFDM) communication system to adapt a maximal unambiguous velocity and distance.

An embodiment of the present invention provides a joint sensing method for an orthogonal frequency domain multiplexing (OFDM) communication system comprises configuring a plurality of reference signal (RS) patterns according to a delay and Doppler shift detection of a measured signal; and determining a two-dimensional (2D) self-ambiguity function according to a delay and sum approach; wherein the delay and sum approach is determined based on linear convolution and frequency binning in a time domain of the plurality of RS patterns; wherein the plurality of RS patterns are for a comb structure.

Another embodiment of the present invention provides a User Equipment (UE) of an orthogonal frequency domain multiplexing (OFDM) communication system, comprises a wireless transceiver, configured to perform wireless transmission and reception to and from a service network; and a controller, configured to configure a plurality of reference signal (RS) patterns according to a delay and Doppler shift detection of a measured signal; and to determine a two-dimensional (2D) self-ambiguity function according to a delay and sum approach; wherein the delay and sum approach is determined based on linear convolution and frequency binning in a time domain of the plurality of RS patterns; wherein the plurality of RS patterns are for a comb structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIG. 2 is a schematic diagram of a comb structure of reference signal (RS) pattern according to an embodiment of the present invention.

FIGS. 3-5 are schematic diagrams of a contour of the 2-dimensional (2D) ambiguity function according to an embodiment of the present invention.

FIGS. 6a, 6b, 6c, 6d, 6e, 6f are schematic diagrams of a contour of the 2D ambiguity function according to an embodiment of the present invention.

FIGS. 7a, 7b, 7c, 7d, 7e, 7f are schematic diagrams of a contour of the 2D ambiguity function according to an embodiment of the present invention.

FIG. 8 is a schematic diagram of a joint sensing method for an OFDM communication system according to an embodiment of the present invention.

### DETAILED DESCRIPTION

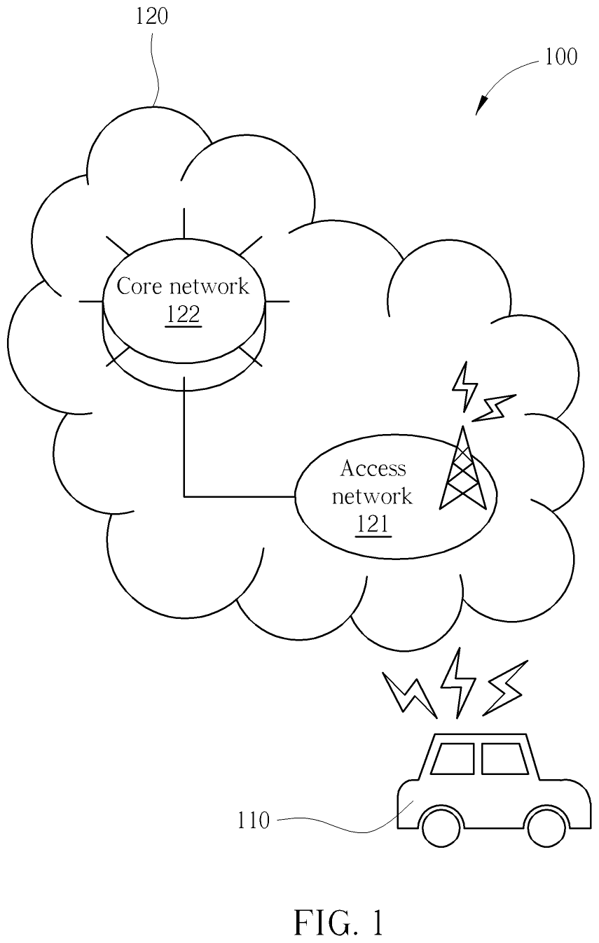

FIG. 1 is a schematic diagram of a wireless communication network 100 according to an embodiment of the present invention.

As shown in FIG. 1, the wireless communication network 100 may include a user equipment (UE) 110 and a service network 120, wherein the UE 110 may be wirelessly connected to the service network 120 for obtaining mobile services and performing cell measurements on the cell (s) of the service network 120.

The UE 110 may be a feature phone, a smartphone, a panel Personal Computer (PC), a laptop computer, a moving vehicle or any wireless communication device supporting the wireless technology (e.g., the 5G NR technology) utilized by the service network 120. In another embodiment, the UE 110 may support more than one wireless technology. For example, the UE may support the 5G NR technology and a legacy 4G technology, such as the LTE/LTE-A/TD-LTE technology.

The service network 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHZ), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QOS). Based on the information, the PCF determines policies about mobility and session management to make the AMF and the SMF operate properly. The AUSF stores data for authentication of UEs, while the UDM stores subscription data of UEs.

In another embodiment, the service network 120 may be an LTE/LTE-A/TD-LTE network, and the access network 121 may be an Evolved-Universal Terrestrial Radio Access Network (E-UTRAN) and the core network 122 may be an Evolved Packet Core (EPC).

An E-UTRAN may include at least one cellular station, such as an evolved NodeB (eNB) (e.g., macro eNB, femto eNB, or pico eNB), each of which may form a cell for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include a Home Subscriber Server (HSS), Mobility Management Entity (MME), Serving Gateway (S-GW), and Packet Data Network Gateway (PDN-GW or P-GW).

It should be understood that the wireless communication network 100 described in the embodiment of FIG. 1 is for illustrative purposes only and is not intended to limit the scope of the application. For example, the wireless communication network 100 may include both a 5G NR network and a legacy network (e.g., an LTE/LTE-A/TD-LTE network, or a WCDMA network), and the UE 110 may be wirelessly connected to both the 5G NR network and the legacy network.

According to an embodiment of the present invention, a staggered comb structure of reference signal (RS) pattern for an orthogonal frequency domain multiplexing (OFDM) communication system is introduced, such that a two-dimensional (2D) self-ambiguity function, e.g., based on delay and sum, may exhibit higher maximum unambiguous velocity, i.e. Doppler frequency, with respect to a changing distance, i.e. time delay, of measured signal.

More specifically, the delay and sum approach may be applied to new 6G joint communication sensing, improvement over existing 5G NR, or reference signal (RS) patterns. In addition, a joint sensing method utilizing the RS patterns according to an embodiment of the present invention for adapting the maximum unambiguous velocity and distance is provided.

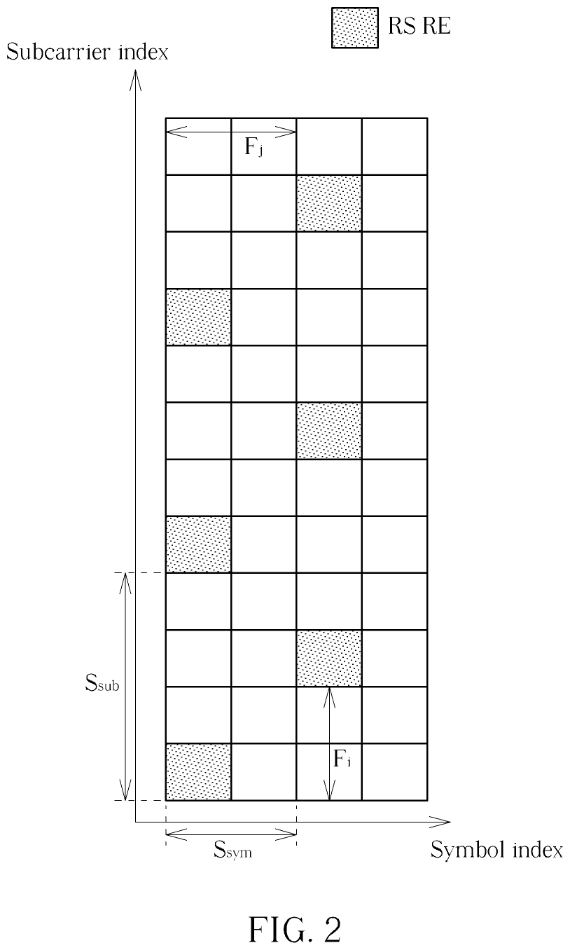

Please refer to FIG. 2, which is a schematic diagram of a comb structure of an RS pattern according to an embodiment of the present invention. The RS pattern includes a plurality of RS resource elements (RE).

As shown in FIG. 2, S_{sub} unit in subcarrier numbers denotes a spacing of non-zero REs in a frequency domain, S_{sym} unit in symbol numbers denotes a spacing of the RS symbols in a time domain, Fᵢ unit in subcarrier numbers be a staggering offset in the frequency domain of the iₜₕ RS symbol, and Fⱼ unit in the subcarrier numbers denotes the staggering offset in the frequency domain of a jₜₕ RS symbol. T=T_{S}+T_{cp} denotes an OFDM symbol duration plus cyclic prefix (CP) duration, where Tₛ denotes OFDM duration, and T_{cp} denotes the CP duration.

With a fixed number of non-zero REs, larger S_{sub} yields better Doppler frequency resolution, larger S_{sym} and better time delay resolution. On the other hand, different S_{sub} and S_{sym} introduce different ambiguities.

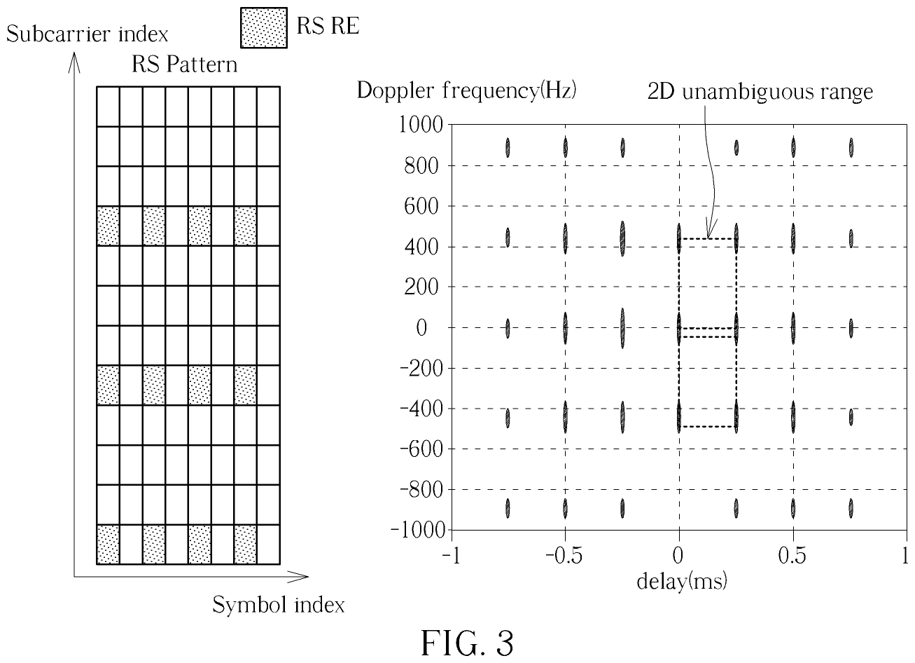

FIGS. 3-5, 6a-6f, 7a-7f illustrate ambiguity peaks with (0, 0) of a contour of the 2D ambiguity function with different cases in delay-Doppler domain.

Case 1: Fᵢ=Fⱼ=constant for any i, j.

The side peak locations are

$$( τ + \frac{l {T}_{s}}{{S}_{s u b}} , f + \frac{k}{{S}_{sym} T} )$$

in the 2D ambiguity functions, except that there are no side peaks at

$$( τ , f \pm \frac{1}{T} ) ,$$

where l=−S_{sub}, −(S_{sub}−1), . . . 0, . . . . S_{sub}−1, S_{sub}, k=−S_{sym}, −(S_{sym}−1), . . . 0, . . . . S_{sym}−1, S_{sym}, (k,l)≠(0,0) and (τ, f) is a true delay and Doppler frequency pair. FIG. 3 shows the example of S_{sub}=4, S_{sym}=2, Fᵢ=Fⱼ=0, (τ, f)=(0,0).

Depending on the application scenarios, different cases of the maximum 2D unambiguous range of the 2D ambiguity function around the true delay and Doppler frequency pair (0,0) are as follows: (FIG. 3 shows an example of maximum 2D unambiguous range):
1) In the case of S_{sym}>1, for time delay from 0 to

$$\frac{{T}_{s}}{{S}_{s u b}} ,$$

Doppler frequency from I to

$$I + \frac{1}{{S}_{sym} T} ,$$

where I is a specified value and

$$- \frac{1}{{S}_{sym} T} \leq I \leq 0 ;$$

2) In the case of S_{sym}=1, for time delay from 0 to

$$\frac{{T}_{s}}{{S}_{s u b}} ,$$

Doppler frequency from I to

$$I + \frac{N}{T} ,$$

where I is a specified value and

$$- \frac{N}{T} \leq I \leq 0 ,$$

where N is subcarrier number.
Case 2: Staggering offset similar to positioning reference signal (PRS). When S_{sym}=1, the pattern is PRS.

Depending on the application scenarios, different cases of the maximum 2D unambiguous range around the true delay and Doppler frequency pair (0,0) are as follows: (FIG. 4 shows an example of maximum 2D unambiguous range)
1) In the case of S_{sym}>1 and time delay from 0 to

$$\frac{{T}_{s}}{{S}_{s u b}} ,$$

Doppler frequency from I to

$$I + \frac{1}{{S}_{sym} T} ,$$

where I is a specified value and

$$- \frac{1}{{S}_{sym} T} \leq I \leq 0 ;$$

2) In the case of S_{sym}=1, for time delay from 0 to

$$\frac{{T}_{s}}{{S}_{s u b}} ,$$

Doppler frequency from I to

$$I + \frac{N}{T} ,$$

where I is a specified value and

$$- \frac{N}{T} \leq I \leq 0 ,$$

where N is subcarrier number;
3) Time delay from 0 to T_{S}, Doppler frequency from J to

$$J + \frac{1}{{S}_{s y m} {S}_{s u b} T} ,$$

where J is a specified value and

$$- \frac{1}{{S}_{s y m} {S}_{s u b} T} \leq J \leq 0.$$

Case 3: Staggering on two RS symbols when S_{sub} is even, (i.e.,

$${F}_{1} = f , {F}_{2} = {F}_{1} + \frac{{S}_{s u b}}{2} , where 0 \leq f < \frac{{S}_{s u b}}{2} ) .$$

For l is even, the side peak locations are

$$( τ + \frac{{l}_{1} {T}_{s}}{{S}_{s u b}} , f + \frac{{k}_{1}}{{S}_{sym} T} )$$

in the 2D ambiguity functions, except that there are no side peaks at

$$( τ , f \pm \frac{1}{T} ) ,$$

where l₁=−S_{sub}, −(S_{sub}−2), . . . 0, . . . . S_{sub}−2, S_{sub}, k₁=−S_{sym}, −(S_{sym}−1), . . . 0, . . . . S_{sym}−1, S_{sym}, (k₁,l₁)≠(0,0) and (τ, f) is a true delay and Doppler frequency pair.

For l is odd, the side peak locations are

$$( τ + \frac{{l}_{2} {T}_{S}}{{S}_{sub}} , f + \frac{\frac{1}{2} + {k}_{2}}{{S}_{sym} T} )$$

in the 2D ambiguity functions, where l₂=−(S_{sub}−1), −(S_{sub}−3), . . . 1, . . . . S_{sub}−3, S_{sub}−1, k₂=−S_{sym}, −(S_{sym}−1), . . . 0, . . . . S_{sym}−1, S_{sym}, (k₂, l₂)≠(0,0) and (τ, f) is a true delay and Doppler frequency pair.

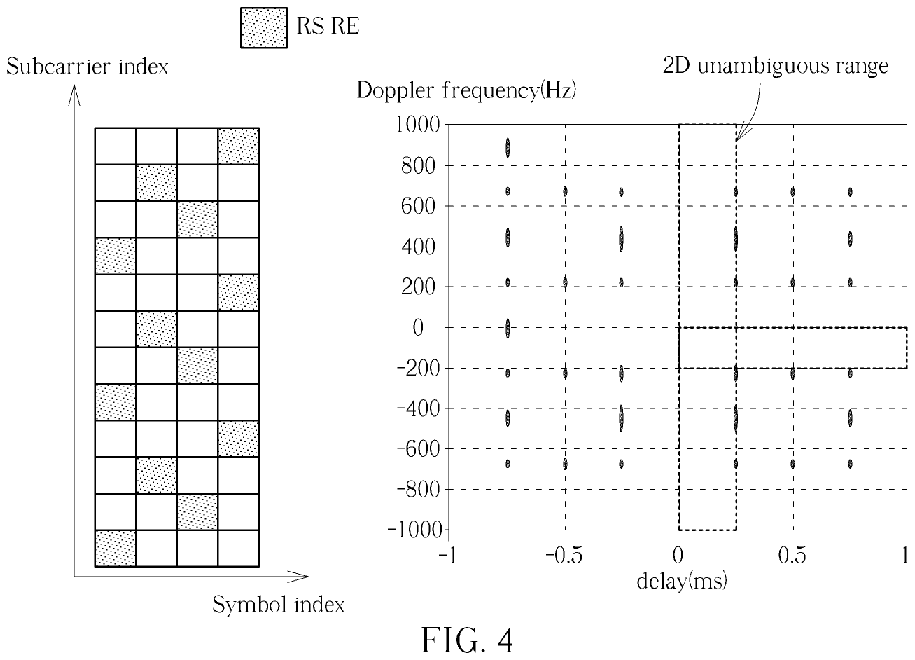

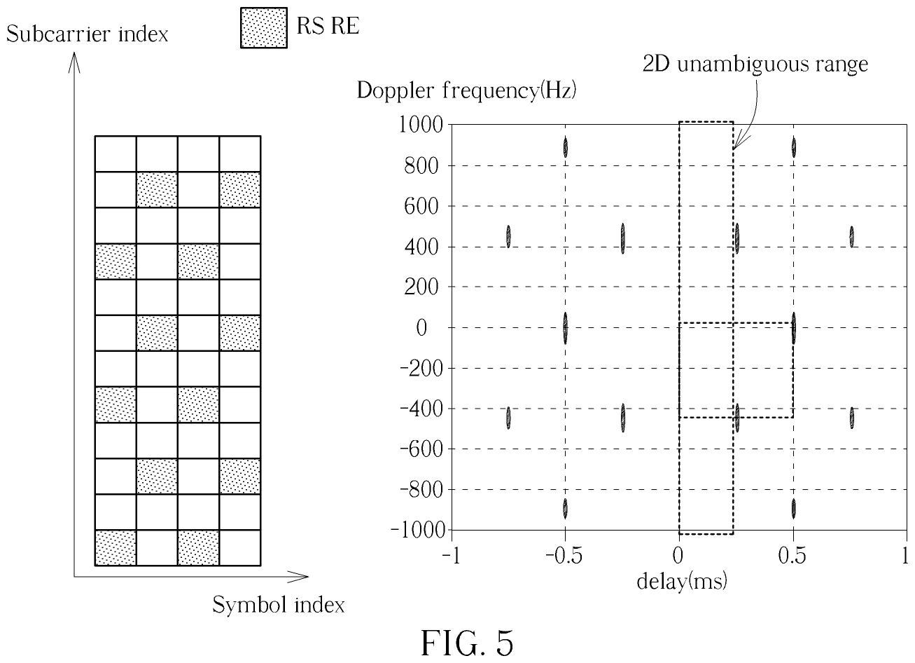

FIG. 5 illustrates an example of S_{sub}=4, S_{sym}=1, F₁=0, F₂=2, (τ, f)=(0,0). Depending on the application scenarios, the maximum 2D unambiguous range around the true delay and Doppler frequency pair (0,0) may be:
1) In the case of S_{sym}>1 and time delay from 0 to

$$\frac{{T}_{s}}{{S}_{s u b}} ,$$

Doppler frequency from I to

$$I + \frac{1}{{S}_{sym} T} ,$$

where I is a specified value and

$$- \frac{1}{{S}_{sym} T} \leq I \leq 0 ;$$

2) In the case of S_{sym}=1, for time delay from 0 to

$$\frac{{T}_{s}}{{S}_{s u b}} ,$$

Doppler frequency from I to

$$I + \frac{N}{T} ,$$

where I is a specified value and

$$- \frac{N}{T} \leq I \leq 0 ,$$

where N is subcarrier number;
3) Time delay from 0 to

$$\frac{2 {T}_{s}}{{S}_{s u b}} ,$$

Doppler frequency from J to

$$J + \frac{1}{2 {S}_{s y m} T} ,$$

where J is a specified value and

$$- \frac{1}{2 {S}_{s y m} T} \leq J \leq 0.$$

Case 4: Fᵢ=mod(i+β₁, S_{sub}), i=0, 1, . . . , S_{sub}−1, β₁ ∈{0, 1, . . . . S_{sub}−1}, where i denotes the iₜₕ RS symbol.

The side peak locations are

$$( τ + \frac{{lT}_{s}}{{S}_{s u b}} , f + \frac{1}{{S}_{s u b} {S}_{s y m} T} + \frac{k}{{S}_{sym} T} )$$

in the 2D ambiguity functions, except that there are no side peaks at

$$( τ , f \pm \frac{1}{T} ) ,$$

where l=−S_{sub}, −(S_{sub}−1), . . . 0, . . . . S_{sub}−1, S_{sub}, k=−S_{sym}, −(S_{sym}−1), . . . 0, . . . . S_{sym}−1, S_{sym}, (k,l)≠(0,0) and (τ, f) is a true delay and Doppler frequency pair.

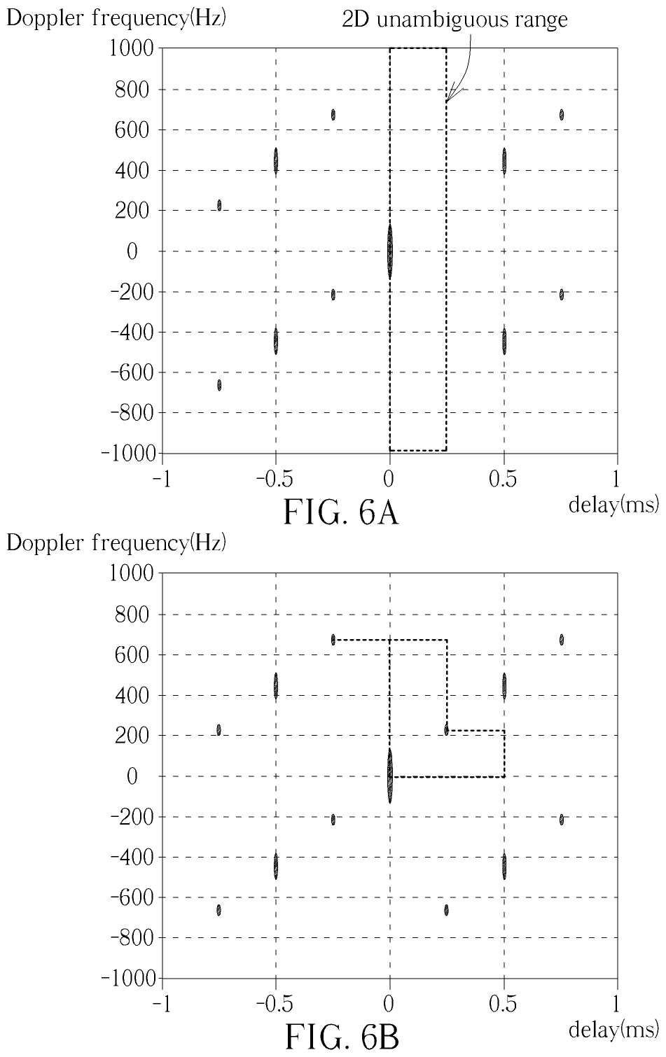

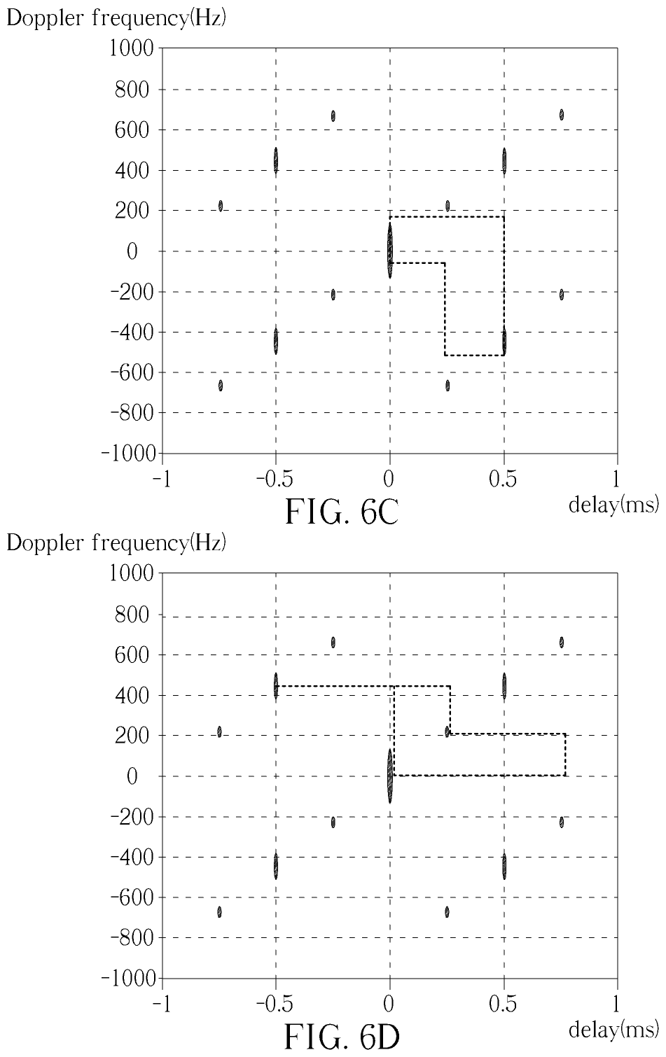

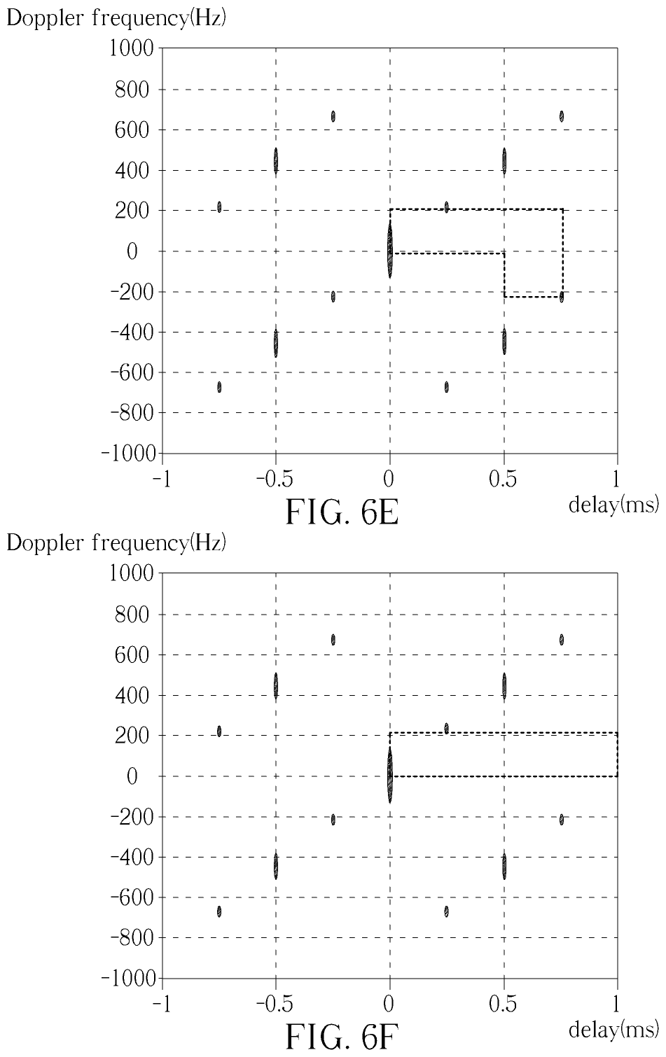

Depending on the application scenarios, the maximum 2D unambiguous range around the true delay and Doppler pair (0,0) shows enhanced flexibility of tuning the maximum unambiguous Doppler frequency and the time delay. FIGS. 6a-6f illustrate 2D unambiguous ranges in the case of S_{sub}=4, S_{sym}=1 with F₁, F₂, F₃, F₄=0, 1, 2, 3 and (τ, f)=(0,0).
1) In the case of S_{sym}>1 and time delay from 0 to

$$\frac{{T}_{s}}{{S}_{sub}} ,$$

Doppler frequency from I to

$$I + \frac{1}{{S}_{sym} T} ,$$

where I is a specified value and

$$- \frac{1}{{S}_{sym} T} \leq I \leq 0 ;$$

2) In the case of S_{sym}=1, for time delay from 0 to

$$\frac{{T}_{s}}{{S}_{sub}} ,$$

Doppler frequency from I to

$$I + \frac{N}{T} ,$$

where I is a specified value and

$$- \frac{N}{T} \leq I \leq 0 ,$$

where N is subcarrier number, FIGS. 6a and 6b depict the examples of 1) and 2) of the case 4;
3) Time delay from 0 to Tₛ, Doppler frequency (f_{d}) from J to

$$J + \frac{1}{{S}_{sym} {S}_{sub} T} ,$$

where J is a specified value and

$$- \frac{1}{{S}_{sym} {S}_{sub} T} \leq J \leq 0 ,$$

as indicated by an instance in FIG. 6f;
4) Time delay (τ) from 0 to

$$\frac{{lT}_{s}}{{S}_{sub}} ,$$

where l=2, . . . S_{sub}−1: The 2D maximum unambiguous range can be expressed as

$$\{ \begin{matrix}J < {f}_{d} < J + \frac{{S}_{sub} - l + 1}{{S}_{sub} {S}_{sym} T} , 0 < τ < \frac{{T}_{s}}{{S}_{sub}} \\ J < {f}_{d} < J + \frac{1}{{S}_{sub} {S}_{sym} T} , \frac{{T}_{s}}{{S}_{sub}} \leq τ < \frac{{lT}_{s}}{{S}_{sub}}\end{matrix} ,$$

where J is a specified value and

$$- \frac{1}{{S}_{sym} {S}_{sub} T} \leq J \leq 0 ,$$

as shown in FIGS. 6b and 6d;
5) Time delay (τ) from 0 to

$$\frac{{lT}_{s}}{{S}_{sub}} ,$$

where l=2, . . . S_{sub}−1:

$$\{ \begin{matrix}J - \frac{{S}_{sub} - l}{{S}_{sub} {S}_{sym} T} < {f}_{d} < J + \frac{1}{{S}_{sub} {S}_{sym} T} , \frac{( l - 1 ) {T}_{s}}{{S}_{sub}} \leq τ < \frac{{lT}_{s}}{{S}_{sub}} \\ J < {f}_{d} < J + \frac{1}{{S}_{sub} {S}_{sym} T} , 0 < τ < \frac{( l - 1 ) {T}_{s}}{{S}_{sub}}\end{matrix} ,$$

where J is a specified value and

$$- \frac{1}{{S}_{sym} {S}_{sub} T} \leq J \leq 0 ,$$

as shown in FIGS. 6c and 6e.
Case 5: Fᵢ=mod(S_{sub}−1−i+β₁, S_{sub}), i=0, 1, . . . , S_{sub}−1, β₁ ∈{0, 1, . . . . S_{sub}−1}, where i denotes the iₜₕ RS symbol.

The side peak locations are

$$( τ + \frac{{lT}_{s}}{{S}_{sub}} , f - \frac{l}{{S}_{sub} {S}_{sym} T} + \frac{k}{{S}_{sym} T} )$$

in the 2D ambiguity functions, except that there are no side peaks at

$$( τ , f \pm \frac{1}{T} ) ,$$

where l=−S_{sub}, −(S_{sub}−1), . . . 0, . . . . S_{sub}−1, S_{sub}, k=−S_{sym}, −(S_{sym}−1), . . . 0, . . . . S_{sym}−1, S_{sym}, (k,l)≠(0,0) and (τ, f) is a true delay and Doppler frequency pair.

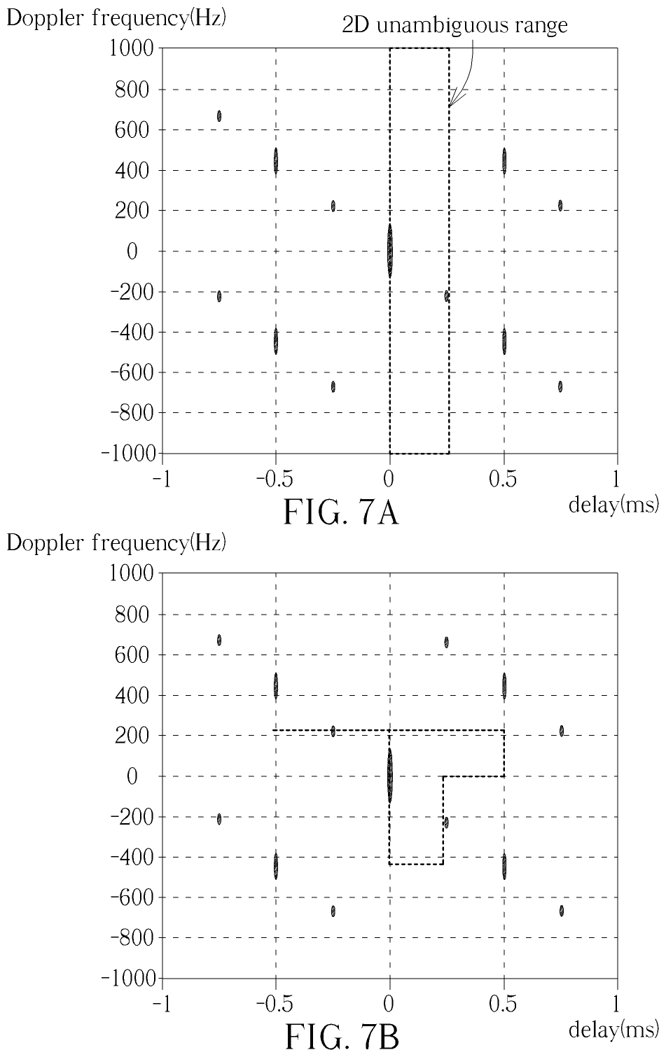

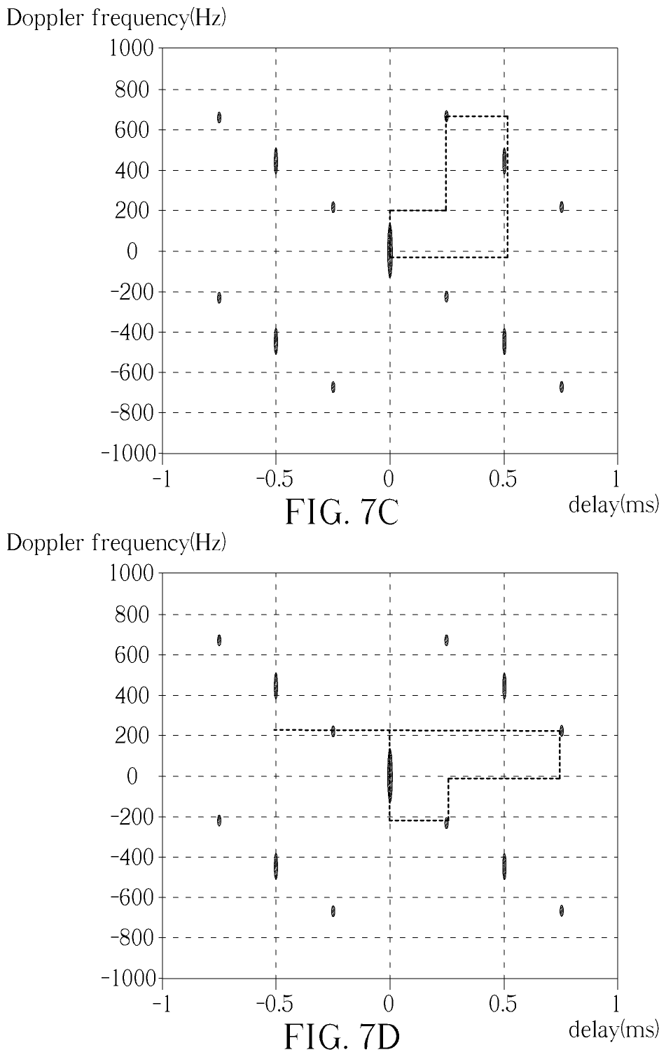

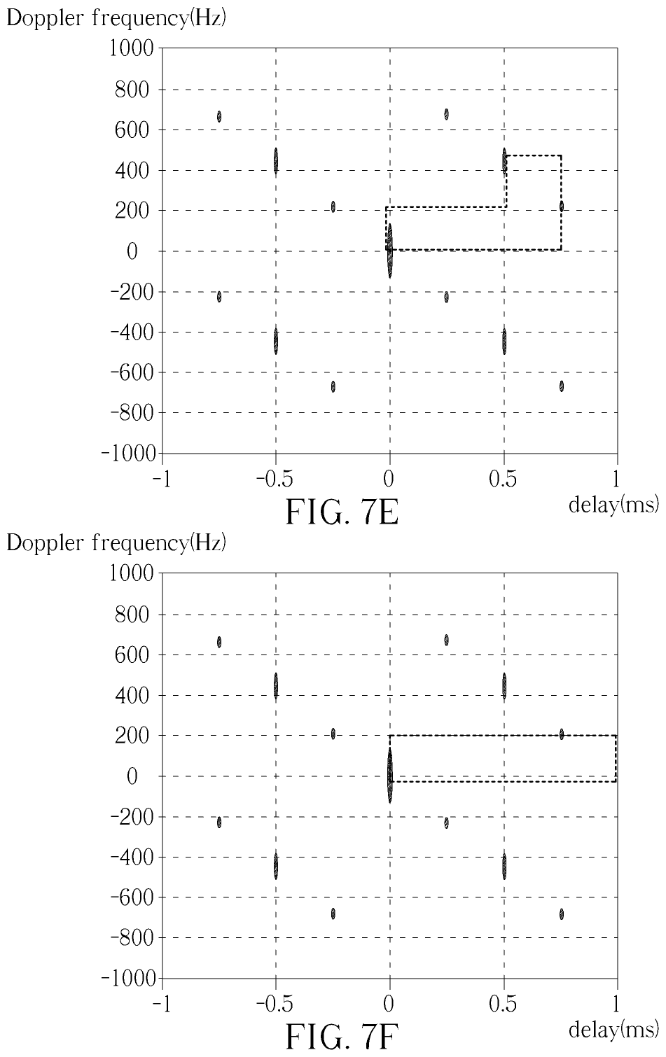

Depending on the application scenarios, the maximum 2D unambiguous range around the true delay and Doppler pair (0,0) shows enhanced flexibility of tuning the maximum unambiguous Doppler frequency and time delay. FIGS. 7a-7f illustrate the 2D unambiguous ranges in the case of S_{sub}=4, S_{sym}=1 with F₁, F₂, F₃, F₄=3, 2, 1, 0 and (τ, f)=(0,0).
1) In the case of S_{sym}>1 and time delay from 0 to

$$\frac{{T}_{s}}{{S}_{sub}} ,$$

Doppler frequency from I to

$$I + \frac{1}{{S}_{sym} T} ,$$

where I is a specified value and

$$- \frac{1}{{S}_{sym} T} \leq I \leq 0 ;$$

2) In the case of S_{sym}=1, for time delay from 0 to

$$\frac{{T}_{s}}{{S}_{sub}} ,$$

Doppler frequency from I to

$$I + \frac{N}{T} ,$$

where I is a specified value and

$$- \frac{N}{T} \leq I \leq 0 ,$$

where N is subcarrier number. FIGS. 7a and 7b depict the examples of 1) and 2) of the case 5;
3) Time delay from 0 to Tₛ, Doppler frequency (f_{d}) from J to

$$J + \frac{1}{{S}_{sym} {S}_{sub} T} ,$$

where J is a specified value and

$$- \frac{1}{{S}_{sym} {S}_{sub} T} \leq J \leq 0 ,$$

as indicated by an instance in FIG. 7f;
4) Time delay (τ) from 0 to

$$\frac{{lT}_{s}}{{S}_{sub}} ,$$

where l=2, . . . . S_{sub}−1: The 2D maximum unambiguous range can be expressed as

$$\{ \begin{matrix}J - \frac{{S}_{sub} - l}{{S}_{sub} {S}_{sym} T} < {f}_{d} < J + \frac{1}{{S}_{sub} {S}_{sym} T} , 0 < τ < \frac{{T}_{s}}{{S}_{sub}} \\ J < {f}_{d} < J + \frac{1}{{S}_{sub} {S}_{sym} T} , \frac{{T}_{s}}{{S}_{sub}} \leq τ < \frac{{lT}_{s}}{{S}_{sub}}\end{matrix} ,$$

where J is a specified value and

$$- \frac{1}{{S}_{sym} {S}_{sub} T} \leq J \leq 0 ,$$

as indicated by instances in FIGS. 7b and 7d;
5) Time delay (τ) from 0 to

$$\frac{{lT}_{s}}{{S}_{sub}} ,$$

where l=2, . . . . S_{sub}−1:

$$\{ \begin{matrix}J < {f}_{d} < \frac{{S}_{sub} - l + 1}{{S}_{sub} {S}_{sym} T} , \frac{( l - 1 ) {T}_{s}}{{S}_{sub}} \leq τ < \frac{{lT}_{s}}{{S}_{sub}} \\ J < {f}_{d} < J + \frac{1}{{S}_{sub} {S}_{sym} T} , 0 < τ < \frac{( l - 1 ) {T}_{s}}{{S}_{sub}}\end{matrix} ,$$

where J is a specified value and

$$- \frac{1}{{S}_{sym} {S}_{sub} T} \leq J \leq 0 ,$$

as indicated by instances in FIGS. 7c and 7e.

Therefore, according to the above embodiments of the configurations, distance and velocity detection of the communication system RS patterns in radar engineering are considered and the configuration parameters of the distance (i.e. the delay)−velocity (i.e. Doppler shift detection) ambiguity function peaks may be adapted.

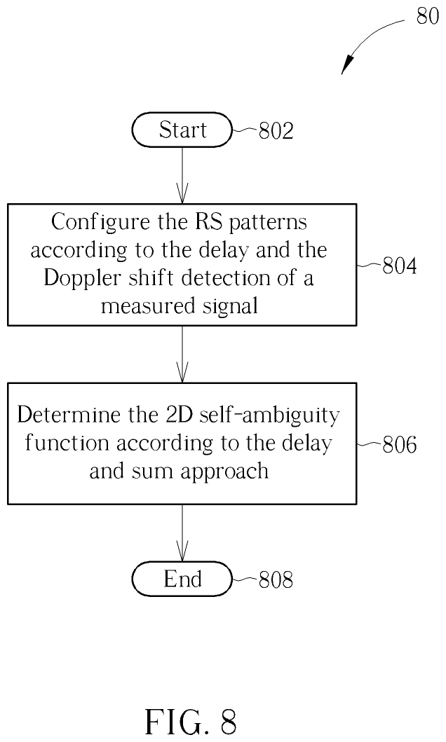

FIG. 8 is a schematic diagram of a joint sensing method 80 for the OFDM communication system according to an embodiment of the present invention. In this embodiment, the joint sensing method 80 may be executed by the wireless communication network 100 or a controller of the UE 110 with a wireless transceiver. The joint sensing method 80 includes the following steps:
Step 802: Start;
Step 804: Configure the RS patterns according to the delay and the Doppler shift detection of a measured signal;
Step 806: Determine the 2D self-ambiguity function according to the delay and sum approach;
Step 808: End.

Refer to the embodiments of the wireless communication network 100 mentioned above for the operation process of the joint sensing method 80, which is not narrated herein for brevity.

Notably, those skilled in the art may properly design the joint sensing method and the UE according to different system requirements, which are not limited thereto.

In summary, the present invention provides a joint sensing method and related user equipment (UE) for an orthogonal frequency domain multiplexing (OFDM) communication system to adapt a maximal unambiguous velocity and distance for the radar signals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A joint sensing method for an orthogonal frequency domain multiplexing (OFDM) communication system, comprising:
configuring a plurality of reference signal (RS) patterns according to a delay and Doppler shift detection of a measured signal; and
determining a two-dimensional (2D) self-ambiguity function according to a delay and sum approach;
wherein the delay and sum approach is determined based on linear convolution and frequency binning in a time domain of the plurality of RS patterns;
wherein the plurality of RS patterns are for a comb structure.

2. The joint sensing method of claim 1, wherein a 2D unambiguous range in a 2D ambiguity function is formed according to a true delay and a Doppler frequency pair of the measured signal.

3. The joint sensing method of claim 2, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Fⱼ unit in the subcarrier numbers denotes the staggering offset in the frequency domain of an jₜₕ RS symbol, Tₛ denotes an OFDM duration, T_{cp} denotes a cyclic prefix (CP) duration, and T=T_{S}+T_{cp} denotes a sum of the OFDM symbol duration and the CP duration.

4. The joint sensing method of claim 3, wherein Fᵢ=Fⱼ for any i,j, the plurality of side peak locations are
$$( τ + \frac{l {T}_{s}}{{S}_{s u b}} , f + \frac{k}{{S}_{sym} T} )$$
in the 2D ambiguity function, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k,l)≠(0,0) wherein (τ, f) denotes the true delay and the Doppler frequency pair of the measured signal.

5. The joint sensing method of claim 4, wherein a maximum 2D unambiguous range around the true delay and the Doppler frequency pair (0, 0) is:
when S_{sym}>1, for time delay from 0 to
$$\frac{{T}_{s}}{{S}_{s u b}} ,$$
the Doppler frequency from I to
$$I + \frac{1}{{S}_{sym} T} ,$$
where I is a specified value and
$$- \frac{1}{{S}_{sym} T} \leq I \leq$$
0; and
when S_{sym}=1, for time delay from 0 to
$$\frac{{T}_{s}}{{S}_{s u b}} ,$$
the Doppler frequency from I to
$$I + \frac{N}{T} ,$$
where I is a specified value and
$$- \frac{N}{T} \leq I \leq 0 ,$$
where N is subcarrier number.

6. The joint sensing method of claim 3, wherein when the staggering offset is similar to positions of the plurality of RSs, a maximum 2D unambiguous range around the true delay and the Doppler frequency pair (0, 0) is:
when S_{sym}>1 and time delay from 0 to
$$\frac{{T}_{s}}{{S}_{s u b}} ,$$
the Doppler frequency from I to
$$I + \frac{1}{{S}_{sym} T} ,$$
where I is a specified value and
$$- \frac{1}{{S}_{sym} T} \leq I \leq 0 ;$$
when S_{sym}=1, for time delay from 0 to
$$\frac{{T}_{s}}{{S}_{s u b}} ,$$
the Doppler frequency from I to
$$I + \frac{N}{T} ,$$
where I is a specified value and
$$- \frac{N}{T} \leq I \leq 0 ,$$
where N is subcarrier number; and
with the time delay from 0 to T_{S}, the Doppler frequency from J to
$$J + \frac{1}{{S}_{sym} {S}_{sub} T} ,$$
where J is a specified value and
$$- \frac{1}{{S}_{sym} {S}_{sub} T} \leq J \leq 0.$$

7. The joint sensing method of claim 3, wherein when S_{sub} is even and staggered on two RS symbols, a maximum 2D unambiguous range around the true delay and the Doppler frequency pair (0, 0) is:
when S_{sym}>1 and time delay from 0 to
$$\frac{{T}_{s}}{{S}_{sub}} ,$$
the Doppler frequency from I to
$$I + \frac{1}{{S}_{sym} T} ,$$
where I is a specified value and
$$- \frac{1}{{S}_{sym} T} \leq I \leq 0 ;$$
when S_{sym}=1, for time delay from 0 to
$$\frac{{T}_{s}}{{S}_{sub}} ,$$
the Doppler frequency from I to
$$I + \frac{N}{T} ,$$
where I is a specified value and
$$- \frac{N}{T} \leq I \leq 0 ,$$
where N is subcarrier number;
with the time delay from 0 to
$$\frac{2 {T}_{s}}{{S}_{sub}} ,$$
the Doppler frequency from J to J+1/2S_{sym}T, where J is a specified value and
$$- \frac{1}{2 {S}_{sym} T} \leq J \leq 0.$$

8. The joint sensing method of claim 3, wherein when Fᵢ=mod(i+β₁, S_{sub}), i=0, 1, . . . , S_{sub}−1, β₁ ∈{0, 1, . . . S_{sub}−1} and i denotes the iₜₕ RS symbol, the plurality of side peak locations are
$$( τ + \frac{{lT}_{s}}{{S}_{sub}} , f + \frac{l}{{S}_{sub} {S}_{sym} T} + \frac{k}{{S}_{sym} T} )$$
the 2D ambiguity function, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k,l)≠(0,0) and (τ, f) is the true delay and the Doppler frequency pair.

9. The joint sensing method of claim 3, wherein when Fᵢ=mod(S_{sub}−1−i+β₁, S_{sub}), i=0, 1, . . . , S_{sub}−1, β₁ ∈{0, 1, . . . S_{sub}−1}, i denotes the iₜₕ RS symbol, a plurality of side peak locations are
$$( τ + \frac{{lT}_{s}}{{S}_{sub}} , f - \frac{l}{{S}_{sub} {S}_{sym} T} + \frac{k}{{S}_{sym} T} )$$
in the 2D ambiguity functions, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k, l)≠(0,0) and (τ, f) is the true delay and the Doppler frequency pair.

10. A user equipment (UE) of an orthogonal frequency domain multiplexing (OFDM) communication system, comprising:
a wireless transceiver, configured to perform wireless transmission and reception to and from a service network; and
a controller, configured to configure a plurality of reference signal (RS) patterns according to a delay and Doppler shift detection of a measured signal; and to determine a two-dimensional (2D) self-ambiguity function according to a delay and sum approach;
wherein the delay and sum approach is determined based on linear convolution and frequency binning in a time domain of the plurality of RS patterns;
wherein the plurality of RS patterns are for a comb structure.

11. The UE of an OFDM communication system of claim 10, wherein a 2D unambiguous range in a 2D ambiguity function is formed according to a true delay and a Doppler frequency pair of the measured signal.

12. The UE of an OFDM communication system of claim 11, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Fⱼ unit in the subcarrier numbers denotes the staggering offset in the frequency domain of an jₜₕ RS symbol, Tₛ denotes an OFDM duration, T_{cp} denotes a cyclic prefix (CP) duration, and T=T_{S}+T_{cp} denotes a sum of the OFDM symbol duration and the CP duration.

13. The UE of an OFDM communication system of claim 12, wherein Fᵢ=Fⱼ for any i,j, the plurality of side peak locations are
$$( τ + \frac{l {T}_{s}}{{S}_{s u b}} , f + \frac{k}{{S}_{sym} T} )$$
in the 2D ambiguity function, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k,l)≠(0,0) wherein (τ, f) denotes the true delay and the Doppler frequency pair of the measured signal.

14. The UE of an OFDM communication system of claim 13, wherein a maximum 2D unambiguous range around the true delay and the Doppler frequency pair (0, 0) is:
when S_{sym}>1, for time delay from 0 to
$$\frac{{T}_{s}}{{S}_{s u b}} ,$$
the Doppler frequency from I to
$$I + \frac{1}{{S}_{sym} T} ,$$
where I is a specified value and
$$- \frac{1}{{S}_{sym} T} \leq I \leq 0 ;$$
and
when S_{sym}=1, for time delay from 0 to
$$\frac{{T}_{s}}{{S}_{s u b}} ,$$
the Doppler frequency from I to
$$I + \frac{N}{T} ,$$
where I is a specified value and
$$- \frac{N}{T} \leq I \leq 0 ,$$
where N is subcarrier number.

15. The UE of an OFDM communication system of claim 12, wherein when the staggering offset is similar to positions of the plurality of RSs, a maximum 2D unambiguous range around the true delay and the Doppler frequency pair (0, 0) is:
when S_{sym}>1 and time delay from 0 to
$$\frac{{T}_{s}}{{S}_{s u b}} ,$$
the Doppler frequency from I to
$$I + \frac{1}{{S}_{sym} T} ,$$
where I is a specified value and
$$- \frac{1}{{S}_{sym} T} \leq I \leq 0 ;$$
when S_{sym}=1, for time delay from 0 to
$$\frac{{T}_{s}}{{S}_{s u b}} ,$$
the Doppler frequency from I to
$$I + \frac{N}{T} ,$$
where I is a specified value and
$$- \frac{N}{T} \leq I \leq 0 ,$$
where N is subcarrier number; and
with the time delay from 0 to Tₛ, the Doppler frequency from J to
$$J + \frac{1}{{S}_{s y m} {S}_{sub} T} ,$$
where J is a specified value and
$$- \frac{1}{{S}_{sym} {S}_{sub} T} \leq J \leq 0.$$

16. The UE of an OFDM communication system of claim 12, wherein when S_{sub} is even and staggered on two RS symbols, a maximum 2D unambiguous range around the true delay and the Doppler frequency pair (0, 0) is:
when S_{sym}>1 and time delay from 0 to
$$\frac{{T}_{s}}{{S}_{sub}} ,$$
the Doppler frequency from I to
$$I + \frac{1}{{S}_{sym} T} ,$$
where I is a specified value and
$$- \frac{1}{{S}_{sym} T} \leq I \leq 0 ;$$
when S_{sym}=1, for time delay from 0 to
$$\frac{{T}_{s}}{{S}_{sub}} ,$$
the Doppler frequency from I to
$$I + \frac{N}{T} ,$$
where I is a specified value and
$$- \frac{N}{T} \leq I \leq 0 ,$$
where N is subcarrier number;
with the time delay from 0 to
$$\frac{2 {T}_{s}}{{S}_{sub}} ,$$
the Doppler frequency from J to
$$J + \frac{1}{2 {S}_{sym} T} ,$$
where J is a specified value and
$$- \frac{1}{2 {S}_{sym} T} \leq J \leq 0.$$

17. The UE of an OFDM communication system of claim 12, wherein when Fᵢ=mod(i+β₁, S_{sub}), i=0, 1, . . . , S_{sub}−1, β₁ ∈{0, 1, . . . S_{sub}−1} and i denotes the iₜₕ RS symbol, the plurality of side peak locations are
$$( τ + \frac{{lT}_{s}}{{S}_{sub}} , f + \frac{l}{{S}_{sub} {S}_{sym} T} + \frac{k}{{S}_{sym} T} )$$
the 2D ambiguity function, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k,l)≠(0,0) and (τ, f) is the true delay and the Doppler frequency pair.

18. The UE of an OFDM communication system of claim 12, wherein when
$${F}_{i} = mod ( {S}_{sub} - 1 - i + {β}_{1} , {S}_{sub} ) , i = 0 , \\ 1 , ... , {S}_{sub} - 1 , {β}_{1} ∈ \{ 0 , 1 , ... , {S}_{sub} - 1 \} , i$$
denotes the iₜₕ RS symbol, a plurality of side peak locations are
$$( τ + \frac{{lT}_{s}}{{S}_{sub}} , f - \frac{l}{{S}_{sub} {S}_{sym} T} + \frac{k}{{S}_{sym} T} )$$
in the 2D ambiguity functions, and no side peak at
$$( τ , f \pm \frac{1}{T} ) ,$$
where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, (k, l)≠(0,0) and (τ, f) is the true delay and the Doppler frequency pair.
